(19) United States
(12) Patent Application Publication
(10) Pub. No.: US 2026/0161932 A1
(43) Pub. Date: Jun. 11, 2026

(54) EFFICIENT MULTIMODAL INPUT PROCESSING USING GENERATIVE ARTIFICIAL INTELLIGENCE MODELS

(71) Applicant: QUALCOMM Incorporated, San Diego, CA (US)

(72) Inventors: Ramchalam KINATTINKARA RAMAKRISHNAN, North York (CA); Zhaocong YUAN, Toronto (CA); Shaojie ZHUO, Richmond Hill (CA); Xiaopeng ZHANG, North York (CA); Chen FENG, Richmond Hill (CA)

(21) Appl. No.: 18/972,492

(22) Filed: Dec. 6, 2024

(51) Int. Cl. G06N 3/0475; G06N 3/08

(52) U.S. Cl. CPC G06N 3/0475; G06N 3/08

(57) ABSTRACT

Certain aspects provide techniques and apparatus for executing actions on a computing device using multimodal inputs and machine learning models. An example method generally includes receiving data at a computing device, the data including data from any of a plurality of data modalities. An encoding representation of the data is generated via a multimodal encoder model configured to process inputs from the plurality of data modalities. Using a generative artificial intelligence model and the encoding representation of the data, a language description of the data is generated. One or more actions are taken based on the generated language description of the data. In some aspects, the multimodal encoder model was distilled into one or more smaller models from a corresponding base model.

### INTRODUCTION

Aspects of the present disclosure relate to processing a series of inputs in computing systems using generative artificial intelligence models.

Computing devices generally include a variety of devices that can ingest inputs to trigger various actions on these computing devices. These actions may be triggered, for example, using generative-artificial-intelligence-model-based assistants that use the inputs ingested from these devices to interact using natural language inputs (e.g., text prompts) generated from the ingested inputs. Generally, these artificial intelligence assistants can be used to perform various tasks through different plugins or other tools that interface with these artificial intelligence assistants. These plugins may, for example, allow users to obtain news from various sources (e.g., weather sources, news outlets, equities market data feeds, etc.), schedule events, plan travel, control robots or other household devices, or the like.

### BRIEF SUMMARY

Certain aspects provide a processor-implemented method for executing actions on a computing device using multimodal inputs and machine learning models. An example method generally includes receiving data at a computing device, the data including data from any of a plurality of data modalities. An encoding representation of the data is generated via a multimodal encoder model configured to process inputs from the plurality of data modalities. Using a generative artificial intelligence model and the encoding representation of the data, a language description of the data is generated. One or more actions are taken based on the generated language description of the data.

Certain aspects provide a processor-implemented method for executing actions on a computing device using multimodal streaming inputs and machine learning models. An example method generally includes receiving streaming data at a computing device, the streaming data including data from any of a plurality of data modalities. An encoding representation of the streaming data is generated via a multimodal encoder model, wherein the multimodal encoder model was distilled into one or more smaller models from a corresponding base model. Using a generative artificial intelligence model and the encoding representation of the streaming data, a language description of the streaming data is generated. One or more actions are taken based on the generated language description of the streaming data.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example of tasks performed using task-specific models in a computing system.

FIG. 2 illustrates an example pipeline for performing tasks in a computing system based on data inputs and a unified multimodal machine learning model, according to certain aspects of the present disclosure.

FIG. 3 illustrates an example of generating an embedding representation of data inputs using a unified multimodal machine learning model, according to certain aspects of the present disclosure.

FIG. 4 illustrates example operations for performing tasks in a computing system based on data inputs and a unified multimodal machine learning model, according to certain aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for processing multimodal inputs in computing systems using generative artificial intelligence models.

Artificial-intelligence-model-based assistants generally allow users to interact with a computing device using natural language inputs in order to execute various tasks on or using the computing device. To do so, an artificial-intelligence-model-based assistant can interface with various software tools that can ingest specific types of information in order to perform specific tasks. For example, an artificial-intelligence-model-based assistant can interface with a first application to respond to requests to add events to a calendar, a second application to respond to requests for the latest news, a third application to respond to requests to book flights or hotel rooms, and the like. These applications generally may be invoked through calling functions exposed by various application programming interfaces (APIs).

In some aspects, input data provided to an artificial intelligence model, such as a generative artificial intelligence model, to perform an action in a computing system may include data in various modalities to perform different tasks. For example, in a facial detection application for unlocking a device, the input data may be a stream or series of image data captured by a camera device. In a voice detection application, the input data may be a stream of audio data or text converted from the audio data captured by an audio capture device. In a sensor data monitoring application, the input data may be sensor data captured by various sensor or metrology devices in the computing device, such as gyroscopes, accelerometers, compasses, satellite navigation receivers, or the like. In order to perform a specific action with respect to a specific type of input, a dedicated machine learning model may be used to process the data and generate outputs (e.g., classifications, segments in an input data stream, etc.) based on which this or another artificial intelligence model performs an action (e.g., identifies an application and an API call relevant to processing the input data).

Different dedicated artificial intelligence models may be used for processing different types of data and performing different tasks. However, each model may impose a computational overhead which may make it impractical to deploy models to cover a large variety of input data modalities for processing and a large variety of tasks to be performed using these artificial intelligence models. For example, multiple models, each of which may have a size in excess of 500 megabytes, may be deployed to a computing device to process different types of data and to perform different tasks based on these different types of data. Because of the limited computational resources available on a computing device such as a smartphone, a tablet computer, a wearable device, or the like, sufficient computational resources may not be available to deploy models for the different types of inputs and the different tasks to be performed on the computing device. Further, because of the size and complexity of these models, the power usage involved in inferencing using these models and the battery capacity of computing devices on which these models execute may not allow for these models to continually execute to process streaming data inputs.

Certain aspects of the present disclosure provide techniques for executing actions on a computing device based on processing input data (e.g., streaming input data) using a unified multimodal encoder model and a generative artificial intelligence model. Generally, the unified multimodal encoder model may be a model distilled from a larger model and configured to generate an encoded version of input data in any of multiple modalities. The encoded version of the input data may be input into a generative model to generate a description of the input data and identify actions to perform on a computing system based on the description of the input data. Because the unified multimodal encoder model may be a model distilled into a smaller-sized model from a larger model, certain aspects of the present disclosure may allow for a single model to be used to process data in different modalities and trigger the execution of various tasks on a computing device. Further, because the unified multimodal encoder model may be a small model (e.g., a model including a small number of parameters relative to a base model from which the unified multimodal encoder model is generated) using a small amount of power and other computational resources, certain aspects of the present disclosure may allow for always-on processing of input data, such as a series of inputs or streaming input data.

### Example Machine Learning Models for Multimodal Data Processing and Task Execution

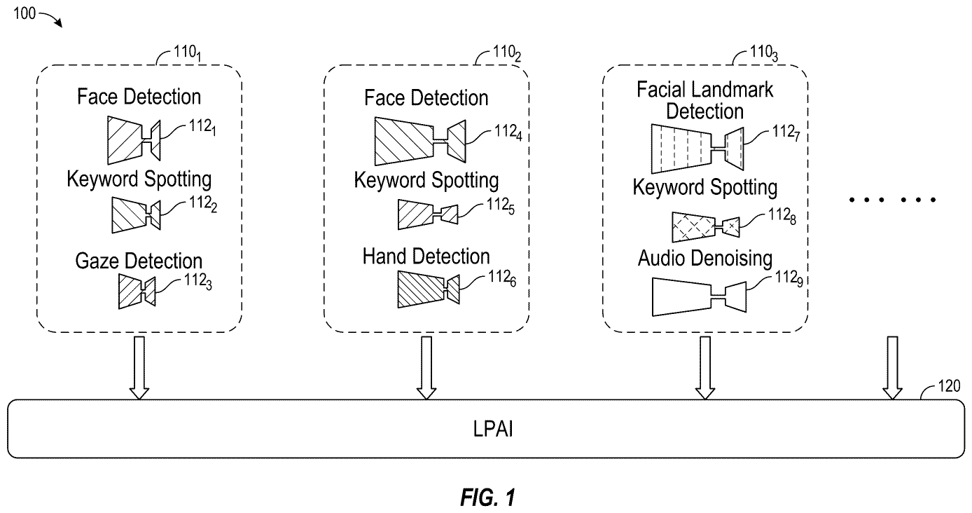

FIG. 1 illustrates an example 100 of tasks performed using task-specific models in a computing system.

As illustrated, to allow for different applications 110₁-110₃ (amongst others not illustrated in FIG. 1, and collectively referred to as “applications 110”) to perform different tasks, each application 110 may include multiple machine learning models 112 that generate outputs that serve as an input into an artificial intelligence model 120 (labeled “LPAI,” or low-power artificial intelligence model). For example, a first application 110 may include a face detection model 112₁ that ingests image data to detect a face in an input image, a keyword spotting model 112₂ to identify specified features in an input image, and a gaze detection model 112₃ that determines a point on a reference plane (e.g., a screen) that a user is looking at based on an input image. A second application 110₂ may, meanwhile, include a face detection model 112₄ (which may be the same as or different from the face detection model 112₁), a keyword spotting model 112₅ (which may be the same as or different from the keyword spotting model 112₂), and a hand detection model 112₆ that ingests image data to identify hands and the locations of detected hands in an image. Finally, as illustrated, a third application 110₃ may include a facial landmark detection model 112₇ that identifies specific features (e.g., eyes, crow's feet, nose, mouth, dimples, etc.) in a face captured in an input image, a keyword spotting model 112₈ (which may be the same as or different from the keyword spotting model 112₂ or 112₅), and an audio denoising model 112₉ that ingests audio data and removes noise from the ingested audio data. It should be recognized that the machine learning models 112 illustrated in FIG. 1 are but examples of machine learning models that can be deployed to process various types of data and perform various tasks.

In some cases, the applications 110₁, 110₂, 110₃ may perform the same or similar tasks using different instances of a machine learning model. For example, the face detection models 112₁ and 112₄ generally perform the same task of detecting a human face in an input of image data. Similarly, the keyword spotting models 112₂, 112₅, 112₈ generally perform the same task of identifying instances of a keyword in an input data stream, such as specific features in an image, utterances of words in an audio stream that trigger the invocation of various features of an artificial-intelligence-model-based assistant, or the like. Still further, while the gaze detection model 112₃, the hand detection model 112₆, and the facial landmark detection model 112₇ are trained to detect different features in an image, the base task that these models are trained to perform may be similar.

Because the machine learning models 112 used for different applications 110 may be duplicative or may perform similar tasks, deploying the applications 110 on a computing device may result in the deployment of a large number of models, some of which may be duplicative. Each of these models may use storage space in permanent storage on a computing device and use system memory when executing on the computing device. As discussed, because a computing device may generally have a limited amount of computing resources available for storing and executing machine learning models, the duplication of machine learning models that perform the same task and the deployment of machine learning models that perform similar tasks may waste resources on a computing device.

### Example Input Data Processing and Task Execution Using a Unified Multimodal Machine Learning Model

To reduce the computational expense involved in using machine learning models to perform various tasks related to different data modalities, certain aspects of the present disclosure provide techniques for processing multimodal data through a unified machine learning model and using the outputs of the unified machine learning model to generate natural language outputs. The natural language outputs can be ingested by a generative-artificial-intelligence-model-based assistant, in some examples, to trigger the execution of relevant tasks on a computing device. Generally, because the unified multimodal machine learning model can ingest data in various modalities, a single model may be deployed instead of deploying multiple models, some of which may be duplicative, or a reduced number of models may be deployed. Further, the unified multimodal machine learning model may be distilled into a reduced-size model relative to a base model. Because the unified multimodal machine learning model may be distilled into a reduced-size model, the unified multimodal machine learning model may allow for continuous inferencing on computing devices while using limited amounts of power and computing resources during operation.

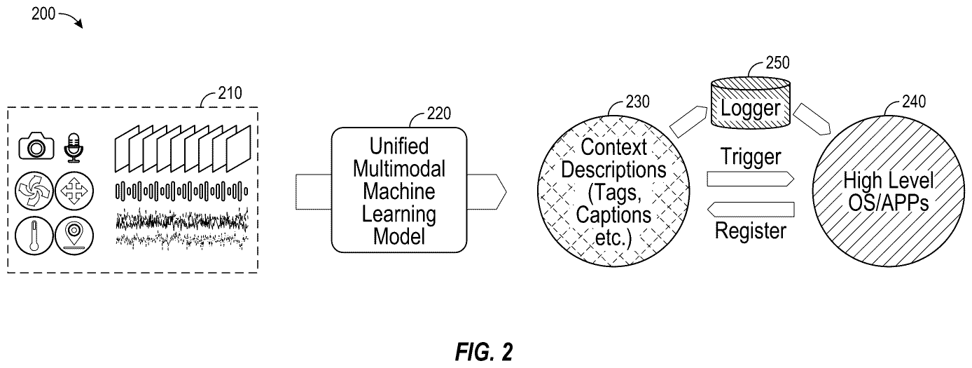

FIG. 2 illustrates an example 200 for performing tasks in a computing system based on data inputs and a unified multimodal machine learning model, according to certain aspects of the present disclosure. There may be multiple data inputs, for example in a series or stream.

As illustrated, to perform tasks in a computing system, a plurality of input devices, sensors, or other devices generate input data 210 (e.g., streams of input data) in one or more modalities. The input devices may be communicatively coupled with and/or part of a computing device on which the unified multimodal machine learning model operates. For example, the input devices may include an image data capture device configured to capture a stream or series of images, an audio data capture device configured to capture a stream of audio data, various sensors configured to capture streams of data related to these sensors (e.g., as a text stream of numerical sensor data, such as a text stream of raw voltages or other raw data captured directly by these sensors, a text stream of data generated from the raw data captured by these sensors, etc.). While FIG. 2 illustrates the input data 210 as being generated by an image data capture device, an audio data capture device, and a sensor device, it should be recognized that the input data 210 (e.g., streams of input data) may be generated by any number of input devices communicatively coupled with or part of a computing device in any of a variety of data modalities.

The input data 210 generated by the plurality of input devices may be input into the unified multimodal machine learning model 220 for processing. Generally, the inputs may be encoded into a compressed representation of the inputs and input into a generative artificial intelligence model (e.g., model 220 or a portion thereof) that generates a contextual description 230 of the input data 210. For example, streaming inputs may be encoded into a compressed representation of the streaming inputs and input into a generative artificial intelligence model that generates a contextual description 230 of the streams of input data 210. The unified multimodal machine learning model 220 may integrate multiple foundational models for data in different modalities into a single model that ingests multimodal data and generates an encoding or embedding representation of input data 210, for example for one or more streams of input data 210. An encoding may be, for example, a numerical representation of a stream of input data, and an embedding representation may be, for example, a vector representing a stream of input data in a compressed format. Generally, the unified multimodal machine learning model 220 may use different instances of an encoder to generate the encoding or embedding representations of the input data 210.

The encoding or embedding representations of the input data 210 may generally compress the input data 210 into a compressed representation. In some aspects, the compressed representation may be generated based on concatenating the encoding or embedding representations of each discrete (streaming) input in the (streams of) input data 210. By concatenating the encoding or embedding representations of each discrete (streaming) input in the (streams of) input data 210, the compressed representation may allow for the generative artificial intelligence model to generate the contextual description 230 by leveraging contextual relationships between the different (streaming) inputs in the (streams of) input data 210. For example, image data may be correlated with audio data and sensor data captured by different input devices coupled with the computing device; by allowing for the inputs (of different modalities, whether streaming or not) to be combined, each modality of data may provide contextual data for other modalities of data processed by the unified multimodal machine learning model 220.

The encoding or embedding representations of the input data 210 may be input into the generative artificial intelligence model to generate the contextual description 230. Generally, the generative artificial intelligence model may be a large language model (LLM) or large multimodal model (LMM) trained to generate a textual description of the input data 210. The generative artificial intelligence model can generate the contextual description 230 of the input data 210 using autoregressive token generation, with each token corresponding to words or parts of words forming a natural language description of the input data 210.

The contextual description 230 may be committed to an activity log by a logger 250 and may be output to one or more external applications 240 for processing. Generally, generation of the contextual description 230 may serve as a trigger to invoke and execute functions exposed by the one or more external applications 240. To trigger execution of a function exposed by the one or more external applications 240, the contextual description 230 may, in some aspects, be output to another generative artificial intelligence model trained to generate one or more API calls from a natural language input. The natural language input may, in some aspects, be prompt-engineered to specify that this generative artificial intelligence model is to process the contextual description 230 of the input data 210. In some aspects, the natural language input may further include additional contextual information about the state of the computing device, as the current state of the computing device may inform the actions to be performed in response to receiving the input data 210. For example, if the state information indicates that the computing device is locked, the state information may condition this generative artificial intelligence model to generate one or more function calls to attempt to unlock the computing device based on at least a stream or series of image data. In another example, the state information may identify an application that is currently active and generate one or more function calls to execute functions in the identified application.

In some aspects, as discussed, the unified multimodal machine learning model 220 may be a machine learning model generated based on distillation from a larger foundational or base model. To generate the unified multimodal machine learning model 220, the foundational or base model may be progressively distilled into smaller models until a model with a desired size is generated. Generally, progressive distillation may result in the generation of multiple versions of a distilled model, each version having a different size (e.g., in terms of a number of parameters, a size of the model, etc.). In some aspects, the size of the model deployed on a computing system may be correlated with the computing capabilities present on the computing system. Computing systems with relatively few computing resources, such as wearable devices, Internet-of-Things (IoT) devices, or the like, may use models distilled into a model with a size specified a priori as the smallest size of a distilled model. Meanwhile, computing devices with more computing resources (e.g., more memory, processing capabilities, etc.) may use models distilled into a model with a size larger than the a-priori-defined smallest size of a distilled model.

In some aspects, the unified multimodal machine learning model 220 may be trained based on distillation of a plurality of larger foundational and/or base models. For example, for a unified multimodal machine learning model 220 that ingests data from a visual modality, an audio modality, and a sensor modality, the foundational or base models from which the unified multimodal machine learning model 220 is trained may include an audiovisual language model, a sensor language model, and an audio and sensor data language model, amongst others. A distillation loss may be calculated between each pair of models to allow for the structure of a model to be learned across the different data modalities for which the unified multimodal machine learning model 220 is configured to process.

In some aspects, the unified multimodal machine learning model 220 may include a base model and one or more adapters (e.g., low-rank adaptation (LoRA) adapters). These adapters may allow for the adaptation of the unified multimodal machine learning model 220 to handle situations across a variety of scenarios. For example, the unified multimodal machine learning model 220 may be generated for a given configuration of input devices on a computing device, and an adapter may be used to adapt the unified multimodal machine learning model 220 for a different configuration of input devices on another computing device (e.g., to account for different imaging capabilities, differences in audio capture quality, etc.). In another example, the unified multimodal machine learning model 220 may be configured to perform tasks with respect to a defined set of data modalities, and an adapter may be used to allow the unified multimodal machine learning model 220 to handle data from a different modality. In yet another example, the unified multimodal machine learning model 220 may be configured to perform a specified set of tasks, and an adapter may be used to allow the unified multimodal machine learning model 220 to perform tasks different from those in the specified set of tasks.

In some aspects, the pipeline illustrated in the example 200 may allow for (low power) always-on, constant inferencing operations performed on a computing device, for example to determine whether to wake up a device or enable certain functionality, or to determine whether a user is recognized or authenticated. Because the unified multimodal machine learning model 220 may be a relatively lightweight model with a limited number of parameters, inferencing operations performed using the unified multimodal machine learning model 220 may be more computationally efficient and may be feasible to execute on computing devices with limited computational resources. For example, because the unified multimodal machine learning model 220 may support data processing across a variety of modalities and may support the execution of different tasks using a machine learning model, the size of the model may scale more slowly than the cumulative size of multiple single-modality models deployed on a computing device. Further, inference latency may remain relatively consistent as the number of tasks and the modalities of data supported by the unified multimodal machine learning model increases, as opposed to techniques in which different models are maintained for each task to be performed based on input data (e.g., streaming input data).

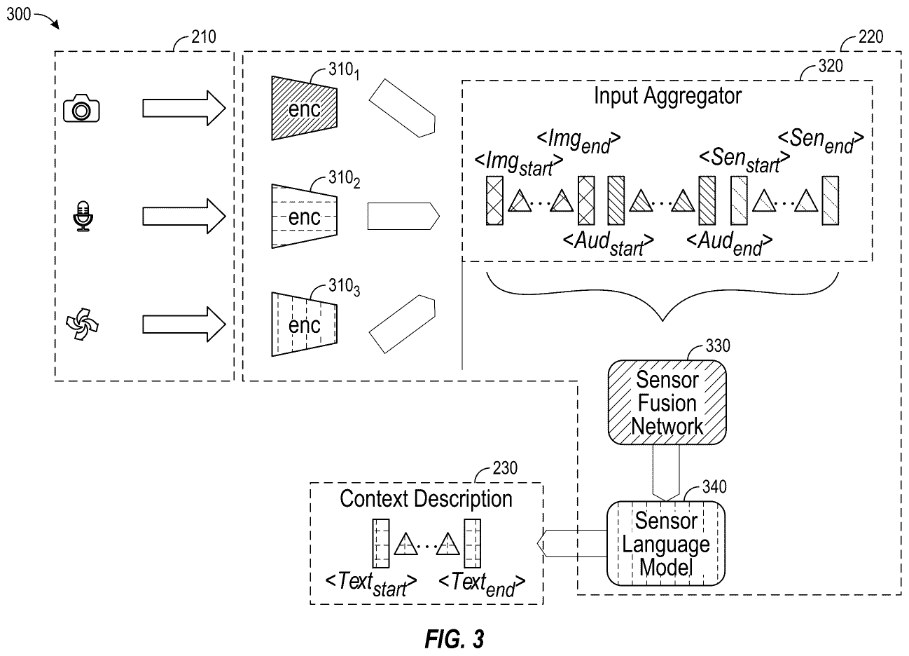

FIG. 3 illustrates an example 300 of generating an embedding representation of data inputs using a unified multimodal machine learning model (e.g., the unified multimodal machine learning model 220 illustrated in FIG. 2), according to certain aspects of the present disclosure.

In the example 300, input data 210 (e.g., one or more streams of input data) received from one or more input devices may be input into the unified multimodal machine learning model 220 for processing, as discussed above with respect to FIG. 2. The one or more input devices may include image capture devices, audio capture devices, text input devices, sensors, or other devices through which data can be obtained from a user of a computing device or generated (e.g., based on the environment in which the computing device operates) and ingested by the computing device.

In some aspects, as illustrated in the example 300, the unified multimodal machine learning model 220 may include a plurality of encoder heads 310₁, 310₂, 310₃ (amongst others not illustrated in FIG. 3, and collectively referred to as “encoder heads 310”) configured to encode different (streaming) inputs into an encoding or embedding representation. Generally, the encoder heads 310 can generate an encoding or embedding representation of input (streaming) data in a same or similar encoding or embedding space regardless of the modality of the input (streaming) data.

Based on the encodings or embedding representations generated by the encoder heads 310 for the different modalities of data received as input into a computing system, an input aggregator 320 can aggregate the encodings and embeddings into a unified encoding. For example, the input aggregator 320 may generate the unified encoding by concatenating the encodings (embeddings) for different modalities into a concatenated encoding, such that the encodings for input data in a first modality are followed by the encodings for input data in a second modality, and so on. In other examples, encodings of one or more modalities are interleaved with encodings for one or more other modalities. In some aspects, the encodings for input data in different modalities may be separated by tags or other information indicating the type of the data modality for which a set of encodings or embeddings applies.

The encodings generated by the encoder heads 310 and (optionally) aggregated into a concatenated encoding by the input aggregator 320 may be input into a sensor fusion network 330 for further processing. Generally, the sensor fusion network 330 may be a neural network or other machine learning model that generates a unified encoding representative of the input data across each of the modalities of the input data, for example a unified encoding representative of streaming input data across each of the modalities of the streaming input data. The unified encoding generated by the sensor fusion network 330 may, in some aspects, be a point or other representation located in a common space. To allow for the unified encoding to be used as an input into a sensor language model 340, the unified encoding may be tokenized into a tokenized input, with each token in the tokenized input representing the unified encoding or a portion thereof.

The sensor language model 340 may be a generative artificial intelligence model, such as a large language model, that is configured to generate the contextual description 230 as a natural language representation of the (streaming) input data 210. The natural language representation of the input data may, for example, describe the input data 210 and correlations between the different modalities of the input data 210. For example, the natural language representation of the (streaming) input data may include a description of objects detected in image data and actions being performed by the detected objects (if any). The description of the actions being performed by the detected objects may be informed, for example, by the audio data, sensor data, and other inputs into the computing system. In some aspects, the audio data may be represented in the contextual description as a textual summary of the audio, such as a textual summary of ambient sounds, a textual summary of speech input into the computing system by a subject identified in the image data, or the like. The description of sensor data may, for example, include a summary of the data obtained by the sensors, including information such as a consistency of the data, events detected by these sensors, or the like.

### Example Operations for Input Data Processing and Task Execution Using a Unified Multimodal Machine Learning Model

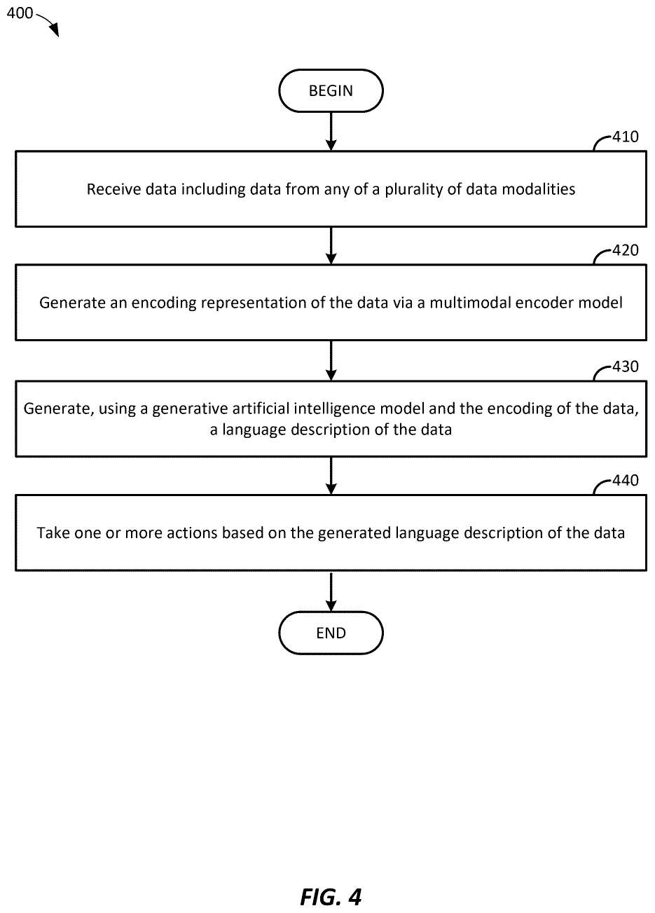

FIG. 4 illustrates example operations 400 for performing tasks in a computing system based on data inputs and a unified multimodal machine learning model, according to certain aspects of the present disclosure. In some aspects, the operations 400 may be performed by a computing device, such as a mobile phone, a tablet computer, a laptop computer, an Internet-of-Things (IoT) device, or other computing device on which a unified multimodal machine learning model (e.g., the unified multimodal machine learning model 220 illustrated in FIGS. 2 and 3) executes based on the ingestion of data in one or more modalities from input devices coupled with the computing device.

As illustrated, the operations 400 begin at block 410, with receiving data at a computing device, the data including data from any of a plurality of data modalities (e.g., data from multiple modalities). In some aspects, the plurality of data modalities may include, without limitation, one or more of an image data modality, an audio modality, or a sensor data modality. The data may include a plurality of inputs from one or more of the modalities, for example a series or stream of inputs for each modality.

At block 420, the operations 400 proceed with generating an encoding representation of the data via a multimodal encoder model. The multimodal encoder model is capable of processing inputs from the plurality of data modalities. As noted above, the data may include streaming data.

The multimodal encoder model may be a model distilled into one or more smaller models from a corresponding base model. In some aspects, the multimodal encoder model may be a model that was progressively distilled from the corresponding base model. In progressively distilling the multimodal encoder model, the size of the model may decrease over each iteration of distilling the model until the model is a desired size (e.g., includes a number of parameters that will allow for accurate inferencing on a computing device while being able to execute continuously and under power and other resource utilization constraints defined for the computing device).

In some aspects, the size of the multimodal encoder model may vary based on an amount of memory associated for the computing device. For example, when the computing device is a mobile phone, the size of the multimodal encoder model may be smaller than a size of a base multimodal model deployed on a cloud computing instance and larger than a size of a multimodal model deployed on an Internet of Things device.

In some aspects, generating the encoding representation of the data includes generating a plurality of encodings, each encoding being associated with data from a respective modality. For example, a first encoding associated with an image data modality may be generated by a first encoder head of the multimodal encoder model, a second encoding associated with an audio data modality may be generated by a second encoder head of the multimodal encoder model, and so on. In some aspects, generating the encoding representation of the data may further include fusing the plurality of encodings into the encoding representation of the data. For example, to fuse the plurality of encodings, the encodings associated with different data modalities may be concatenated with each other. In some aspects, the concatenated encoding may be input into another encoder head (e.g., a sensor fusion network) which may be trained to generate, from the concatenated encoding, an encoding or embedding representation in a unified embedding space.

At block 430, the operations 400 proceed with generating, using a generative artificial intelligence model and the encoding representation of the data, a language description of the data.

In some aspects, the generative artificial intelligence model may be a large language model. The large language model may be configured, for example, to generate the language description of the data conditioned on a language description of prior data. In some examples, the encoding representation may be an encoding representation of streaming data, and the language description may be of streaming data and/or conditioned on a language description of streaming data.

In some aspects, the generative artificial intelligence model may include a base model and one or more adapters. The one or more adapters may be specific to input devices from which the data is received, data modalities, or tasks to be performed on the computing device. For example, the adapters may allow the generative artificial intelligence model to generate responses for different types of input sources than those used to train the base model, for different types of data than that used to train the base model, and/or to execute tasks associated with applications or features of a computing device that were not used in training the base model.

At block 440, the operations 400 proceed with taking one or more actions based on the generated language description of the data.

In some aspects, the one or more actions comprise invoking a function exposed by an application executing on the computing device to process the data (e.g., streaming data) based on the generated language description of the (streaming) data.

In some aspects, the one or more actions comprise outputting, to a display of or coupled with the computing device, the generated language description of the data.

In some aspects, the multimodal encoder model and the generative artificial intelligence model may be configured to execute continuously. In doing so, input devices communicatively coupled with the computing device on which the multimodal encoder model and the generative artificial intelligence model execute may continually ingest data and input the data (e.g., as an input stream) into the multimodal encoder model for processing.

### Example Systems for Input Data Processing and Task Execution Using a Unified Multimodal Machine Learning Model

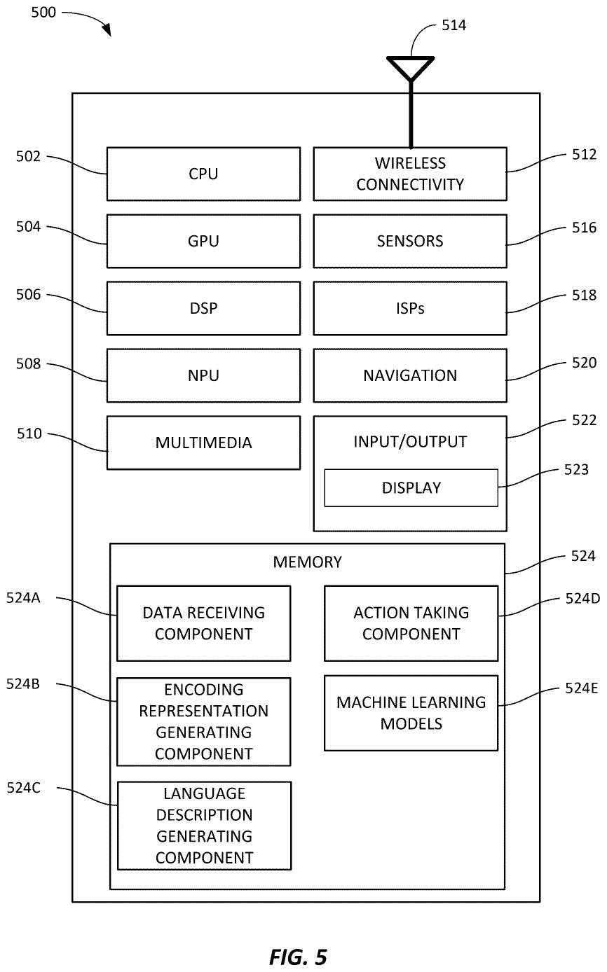

FIG. 5 depicts an example processing system 500 configured to perform various aspects of the present disclosure, including, for example, the techniques and methods described with respect to FIGS. 2-4. The processing system 500 may represent a computing device configured to execute operations based on input data and a unified multimodal machine learning model, as discussed above with respect to FIGS. 2-4. Although depicted as a single system for conceptual clarity, in at least some aspects, as discussed above, the operations described below with respect to the processing system 500 may be distributed across any number of devices.

The processing system 500 includes a central processing unit (CPU) 502, which in some examples may be a multi-core CPU. Instructions executed at the CPU 502 may be loaded, for example, from a program memory associated with the CPU 502 or may be loaded from a partition of memory 524.

The processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation component 520, which may include satellite-based positioning system components (e.g., GPS or GLONASS) as well as inertial positioning system components.

The processing system 500 may also include one or more input and/or output devices 522, such as screens (e.g., a display 523), touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes a data receiving component 524A (which may comprise a streaming data receiving component), an encoding representation generating component 524B, a language description generating component 524C, an action taking component 524D, and one or more machine learning models 524E. Though depicted as discrete components for conceptual clarity in FIG. 5, the illustrated components (and others not depicted) may be collectively or individually implemented in various aspects.

Generally, the processing system 500 and/or components thereof may be configured to perform the methods described herein.

Notably, in other aspects, components of the processing system 500 may be omitted, such as where the processing system 500 is a server computer or the like. For example, the multimedia processing unit 510, the wireless connectivity component 512, the sensor processing units 516, the ISPs 518, and/or the navigation component 520 may be omitted in other aspects. Further, components of the processing system 500 may be distributed between multiple devices.

### Example Clauses

Implementation details of various aspects of the present disclosure are described in the following numbered clauses:
Clause 1: A processor-implemented method for machine learning, comprising: receiving data at a computing device, the data including data from any of a plurality of data modalities; generating an encoding representation of the data via a multimodal encoder model configured to process inputs from the plurality of data modalities; generating, using a generative artificial intelligence model and the encoding representation of the data, a language description of the data; and taking one or more actions based on the generated language description of the data.
Clause 2: The method of Clause 1, wherein the plurality of data modalities comprises one or more of an image data modality, an audio modality, or a sensor data modality.
Clause 3: The method of Clause 1 or 2, wherein a size of the multimodal encoder model varies based on an amount of memory associated with the computing device.
Clause 4: The method of Clause 3, wherein the computing device comprises a mobile phone, and wherein the size of the multimodal encoder model is smaller than a size of a base multimodal model deployed on a cloud computing instance and larger than a size of a multimodal model deployed on an Internet of Things device.
Clause 5: The method of any of Clauses 1 through 4, wherein generating the encoding representation of the data comprises generating a plurality of encodings, each encoding being associated with data from a respective modality.
Clause 6: The method of Clause 5, wherein generating the encoding representation of the data further comprises fusing the plurality of encodings into the encoding representation of the data.
Clause 7: The method of any of Clauses 1 through 6, wherein the generative artificial intelligence model is configured to generate the language description of the data conditioned on a language description of prior data.
Clause 8: The method of any of Clauses 1 through 7, wherein the multimodal encoder model and the generative artificial intelligence model are configured to execute continuously on streaming data.
Clause 9: The method of any of Clauses 1 through 8, wherein the generative artificial intelligence model comprises a base model and an adapter specific to one or more input devices from which the data is received, one or more of the data modalities, or one or more tasks to be performed on the computing device.
Clause 10: The method of any of Clauses 1 through 9, wherein the one or more actions comprise invoking a function exposed by an application executing on the computing device to process the data based on the generated language description of the data.
Clause 11: The method of any of Clauses 1 through 10, wherein the one or more actions comprise outputting, to a display of or coupled with the computing device, the generated language description of the data.
Clause 12: The method of any of Clauses 1 through 11, wherein the multimodal encoder model was distilled into one or more smaller models from a corresponding base model.
Clause 13: The method of Clause 12, wherein the multimodal encoder model was progressively distilled from the corresponding base model.
Clause 14: A processing system comprising: at least one memory comprising computer-executable instructions; and one or more processors coupled to the at least one memory and configured to execute the computer-executable instructions and cause the processing system to perform a method in accordance with any of Clauses 1 through 13.
Clause 15: A processing system comprising means for performing a method in accordance with any of Clauses 1 through 13.
Clause 16: A non-transitory computer-readable medium comprising computer-executable instructions that, when executed by one or more processors of a processing system, cause the processing system to perform a method in accordance with any of Clauses 1 through 13.
Clause 17: A computer program product embodied on a computer-readable storage medium comprising code for performing a method in accordance with any of Clauses 1 through 13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method for machine learning, comprising:
receiving data at a computing device, the data including data from any of a plurality of data modalities;
generating an encoding representation of the data via a multimodal encoder model configured to process inputs from the plurality of data modalities;
generating, using a generative artificial intelligence model and the encoding representation of the data, a language description of the data; and
taking one or more actions based on the generated language description of the data.

2. The method of claim 1, wherein the multimodal encoder model was distilled into one or more smaller models from a corresponding base model.

3. The method of claim 1, wherein the plurality of data modalities comprises one or more of an image data modality, an audio modality, or a sensor data modality.

4. The method of claim 1, wherein a size of the multimodal encoder model varies based on an amount of memory associated with the computing device.

5. The method of claim 4, wherein the computing device comprises a mobile phone, and wherein the size of the multimodal encoder model is smaller than a size of a base multimodal model deployed on a cloud computing instance and larger than a size of a multimodal model deployed on an Internet of Things device.

6. The method of claim 1, wherein generating the encoding representation of the data comprises generating a plurality of encodings, each encoding being associated with data from a respective modality.

7. The method of claim 6, wherein generating the encoding representation of the data further comprises fusing the plurality of encodings into the encoding representation of the data.

8. The method of claim 1, wherein the generative artificial intelligence model is configured to generate the language description of the data conditioned on a language description of prior data.

9. The method of claim 1, wherein the multimodal encoder model and the generative artificial intelligence model are configured to execute continuously on streaming data.

10. The method of claim 1, wherein the generative artificial intelligence model comprises a base model and an adapter specific to one or more input devices from which the data is received, one or more of the data modalities, or one or more tasks to be performed on the computing device.

11. The method of claim 1, wherein the one or more actions comprise invoking a function exposed by an application executing on the computing device to process the data based on the generated language description of the data.

12. The method of claim 1, wherein the one or more actions comprise outputting, to a display of or coupled with the computing device, the generated language description of the data.

13. A processing system for machine learning, comprising:
at least one memory having executable instructions stored thereon; and
one or more processors configured to execute the executable instructions to cause the processing system to:
receive data at the processing system, the data including data from any of a plurality of data modalities;
generate an encoding representation of the data via a multimodal encoder model configured to process inputs from the plurality of data modalities;
generate, using a generative artificial intelligence model and the encoding representation of the data, a language description of the data; and
take one or more actions based on the generated language description of the data.

14. The processing system of claim 13, wherein the plurality of data modalities comprises one or more of an image data modality, an audio modality, or a sensor data modality.

15. The processing system of claim 13, wherein a size of the multimodal encoder model varies based on an amount of memory associated with the processing system.

16. The processing system of claim 13, wherein to generate the encoding representation of the data, the one or more processors are configured to cause the processing system to generate a plurality of encodings, each encoding being associated with data from a respective modality.

17. The processing system of claim 16, wherein to generate the encoding representation of the data, the one or more processors are further configured to cause the processing system to fuse the plurality of encodings into the encoding representation of the data.

18. The processing system of claim 13, wherein the multimodal encoder model and the generative artificial intelligence model are configured to execute continuously on streaming data.

19. The processing system of claim 13, wherein the one or more actions comprise one or more of:
invoking a function exposed by an application executing on the processing system to process the data based on the generated language description of the data, or
outputting, to a display of or coupled with the processing system, the generated language description of the data.

20. A non-transitory computer-readable medium having executable instructions stored thereon which, when executed by one or more processors, cause the one or more processors to perform an operation for machine learning, the operation comprising:
receiving data at a computing device including or coupled to the one or
more processors, the data including data from any of a plurality of data modalities;
generating an encoding representation of the data via a multimodal encoder model configured to process inputs from the plurality of data modalities;
generating, using a generative artificial intelligence model and the encoding representation of the data, a language description of the data; and
taking one or more actions based on the generated language description of the data.
